(19) United States
(12) Patent Application Publication
(10) Pub. No.: US 2018/0096309 A1
(43) Pub. Date: Apr. 5, 2018

(54) INTEGRATED MILITARY MOBILE WORK INFORMATION MANAGEMENT SYSTEM

(71) Applicant: Severn Pacific Inc., Washington, DC (US)

(72) Inventors: John R. Moses, Washington, DC (US); Joshua W. Welle, Washington, DC (US); Joshua M. Awad, Casper, WY (US); Jason Powers, San Francisco, CA (US)

(21) Appl. No.: 15/208,878

(22) Filed: Jul. 13, 2016

Related U.S. Application Data
(60) Provisional application No. 62/192,048, filed on Jul. 13, 2015.

(51) Int. Cl. G06Q 10/10; G06Q 10/06; G06F 21/41; H04W 4/00; H04L 29/08

(52) U.S. Cl. CPC G06Q 10/1097; G06Q 10/0637; G06F 21/41; H04L 67/025; H04W 4/003; H04L 67/10; H04W 4/006

(57) ABSTRACT

A system for integrated military mobile work information management has been conceived and reduced to practice. The system includes a military mobility server and a military mobile client. The military mobility server stores military personnel and equipment related data, stores military task related documents, uses analytics to predict actions to best outcome for military incidents and to create schedules for personnel. The military mobile client receives data from the military mobility server; displays calendar based schedules, provides a viewing platform for work crucial graphical materials; and wirelessly transmits status and report data to the military mobility server.

### CROSS-REFERENCE TO RELATED APPLICATIONS

The present application claims the benefit of and priority to U.S. provisional application Ser. No. 62/192,048 titled “INTEGRATED MILITARY MOBILE WORK MANAGEMENT SYSTEM” filed on Jul. 13, 2015, the entire specification of which is incorporated herein by reference in its entirety.

### BACKGROUND OF THE INVENTION

### Field of the Art

The disclosure relates to the field of enterprise software systems, and more particularly to the field of enterprise software for use on mobile devices in a mobile military environment such as for example a shipboard environment.

### Discussion of the State of the Art

FIG. 14 shows a prior art system comprising a Consolidated Afloat Networking and Enterprise System (CANES) 1400, which is being deployed on Navy ships starting in 2015 and continuing through 2022. CANES makes possible virtualization of legacy shipboard enterprise systems while adopting a single, more modern, high performance 1410, 1420, 1425 and secure network architecture 1430, 1440. While CANES represents a significant step forward for Navy ships in terms of modern networking and enterprise architecture, it is not currently planned to support bring-your-own-device (BYOD) usage opting to service only a small subset of pre-resident devices 1435. That is, sailors and officers who have personal smart phones and tablets are not able to take advantage of the CANES architecture. Furthermore, generally only single-purpose, non-mobile friendly applications are available on the CANES network, and these mostly quite dated which do not make use of highly integrated technologies and workflow practices currently successfully used in the private sector for workforce optimization and operational efficiency.

What is needed is an integrated military mobile work management system that allows BYOD use and that provides a mobile-first set of enterprise applications (apps) that allow, for example, shipboard naval personnel to have integrated apps available at the point of work in support of all of their daily (initially, non-tactical) activities with operationally relevant information being electronically captured without added effort on the part of the user, analyzed, aggregated and intelligently stored so as to be available in the formats and relationships most useful for most inquiries.

### SUMMARY OF THE INVENTION

Accordingly, the inventor has conceived and reduced to practice, in a preferred embodiment of the invention, an integrated military mobile work information management system.

A preferred embodiment of the invention is designed to be the single hub where sailors go when they come to work. Enabled by a single sign-on and protected within the mobile device's approved secure partition, the embodiment provides a platform that hosts its own applications as well as provides a user interface and application programming interface (API) for future apps to be hosted that support surface warfare readiness. The platform concept ensures users are able to find the information they need when they need it at the point of performance. It also allows for innovation within the fleet and the commercial sector by providing a place for good ideas to get into the hands of sailors. The embodiment is an exchange interface platform through which sailors may access applications for daily tasks. The platform is designed to buttress established defense readiness pillars—Personnel, Equipment, Supply, Training, and Ordnance (PESTO)—and resides on mobile tablets and smartphones. The invention adheres to personal identification information (PII) standards and cybersecurity requirements. It may be hosted in an unclassified (UNCLAS) cloud or on the Navy Information Application Product Suite (NIAPS) when the system is WiFi enabled. PESTO pillars define the metrics for fleet readiness. In order to meet these requirements day-to-day, there are myriad paper documents and software programs that independently serve key functions but are not integrated at the point of performance, or, are not available to the warfighter due to infrastructure limitations of few computers. The existing personal computer (PC) administrative tools that support PESTO pillars are cumbersome and do not leverage mature, mobile technology. Until recently, the innovative tools needed to empower every sailor onboard ships were not available. Smart devices, powered by iOS and Android operating systems, changed the way people live and companies operate. The Navy has followed industry's lead to empower sailors with fast deployable tools to unleash sailor talent.

The historical barriers to implementing mobile (bandwidth, devices, and security) are being eliminated. The Navy's information dominance command, SPAWAR, and other key commands are ready to deliver both secure bandwidth and hardware to the fleet. The cost of smart devices continues to decline dramatically while their capabilities are constantly improving The final piece needed to advance mobile tools is a suite of applications that support the PESTO pillars. The invention is the first mobile readiness platform and creates a channel through which future mobile applications may flow. Ensuring the user experience (UX) is best-in-class and the product continues to adapt to sailor demands is a central tenet of the platform according to the invention.

Sailors live in a post-PC era. The technology to run civilian companies from smart devices is no longer new. In fact, the cybersecurity literature explains that mobile SaaS: 1) enhances network security; 2) increases information dominance; 3) saves information technology costs; and 4) raises productivity of users by 30%. Mobile devices are far more than simply a personal computer in a different form factor. Their integrated audio, photo, video, geolocation (accelerometers), and easy addition of other sensors—combined with the fact that they may go anywhere—vastly changes the horizon of work possible with a smart device vs. a PC.

Because the evidence is compelling to go mobile within a workforce, thousands of companies are no longer buying personal computers in order to release the horsepower of the digital economy. War fighting is our Navy's first priority, and the fleet depends on key enablers-training, personnel support, resource-allocation tools—to be ready to answer the nation's call. The readiness platform of the invention is designed to make the enablers easier, faster, more transparent, and significantly more efficient so that our sailors may focus on the real mission—war fighting.

According to a preferred embodiment of the invention, a system for integrated military mobile work information management comprising a military mobility server in a memory of and operating on a processor of a computing device and a military mobile client stored in a memory of and operating on a processor of a mobile computing device. The military mobility server retrieves a plurality of ship related data from a plurality of sources, persistently stores a plurality of data relating to each military unit personnel and military unit equipment, stores a plurality of document data related to military unit operations, uses analytics to predict best course action for military unit incidents and create schedules for each personnel and wirelessly transmits data to the military mobile client. The military mobile client receives a plurality of data types from the military mobility server, provides a graphically based work platform for each military unit personnel graphically displays a plurality of calendar based schedules to each personnel, provides a viewing platform for a plurality of training, maintenance, repair and safety materials, and wirelessly transmits a plurality of status and report data to the military mobility server.

According to another preferred embodiment of the invention, at least a portion of the data related to military unit personnel and military unit equipment are organized into target specific profiles. At least a portion of the schedules created by the military mobility server is a calendar based work task list with at least a task and due date for task completion. At least a portion of the schedules created by the military mobility server is a calendar based training schedule with at least a name of each training unit, a document list for each training unit and a due date for each training unit completion. At least one task making use of analytics capabilities of the military mobility server is management of maintenance for all military unit equipment. At least one task making use of analytics capabilities of the military mobility server is management of repairs to all military unit equipment. At least one use of the military mobile client by each personnel is to manage their schedule commitments. At least one use of the military mobile client by each personnel is to electronically report observations and experiences made during watch duty. At least one of the military mobile clients communicates with the military mobility server over a 4G wireless data network connection. At least one of the military mobile clients communicates with the military mobility server over a secure WiFi wireless data network connection.

According to another preferred embodiment of the invention method for integrated military mobile work information management comprising the steps of: a) receiving a plurality of military unit related data from a plurality of data sources using a military mobility server stored in a memory of and operating on a processor of a computing device; b) storing a plurality of data relating to each military unit personnel and military unit equipment using a persistent data store; c) employing analytics programming to predict best course of action for military unit incidents and to create schedules for each military unit personnel; d) communicating with a military mobile client device using a secure wireless network connection; e) displaying a plurality of calendar based military unit personnel scheduling data in an easy to read and rapidly comprehend graphical format using the military mobile client device; f) providing a viewing platform for plurality of training, maintenance, repair, and safety materials using military mobile client device; g) transmit a plurality of status and report data to military mobility server from military mobile client device.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of the workforce information system according to an embodiment of the invention.

FIG. 2 is a flow diagram illustrating exemplary function of the system according to an embodiment of the invention.

FIG. 3 is a method diagram showing storage organization of ship component related information including personnel using profiles according to an embodiment of the invention.

FIG. 4 is a flow illustrating library document security according to an embodiment of the invention.

FIG. 5 is a system diagram showing the repair cycle for shipboard equipment according to an embodiment of the invention.

FIG. 6 is a flow diagram showing steps on the repair cycle for shipboard equipment according to an embodiment of the invention.

FIG. 7 is a system diagram showing automated scheduling of required workforce personnel training and certification modules according to an embodiment of the invention.

FIG. 8 is a flow diagram showing steps involved in automated scheduling of required workforce personnel training and certification modules according to an embodiment of the invention according to an embodiment of the invention.

FIG. 9 shows a typical mobile device app menu screen according to an embodiment of the invention.

FIG. 10 shows an exemplary document library material access maintenance screen according to an embodiment of the invention.

FIG. 11 shows a typical worklist task screen according to an embodiment of the invention.

FIG. 12 shows a typical shipboard information summary dashboard screen according to an embodiment of the invention.

FIG. 13 illustrates exemplary system analytics mapping a sample equipment maintenance order for inclusion into equipment's profile record according to an embodiment of the invention.

FIG. 14 shows a prior art consolidated afloat network and enterprise system (CANES) architecture.

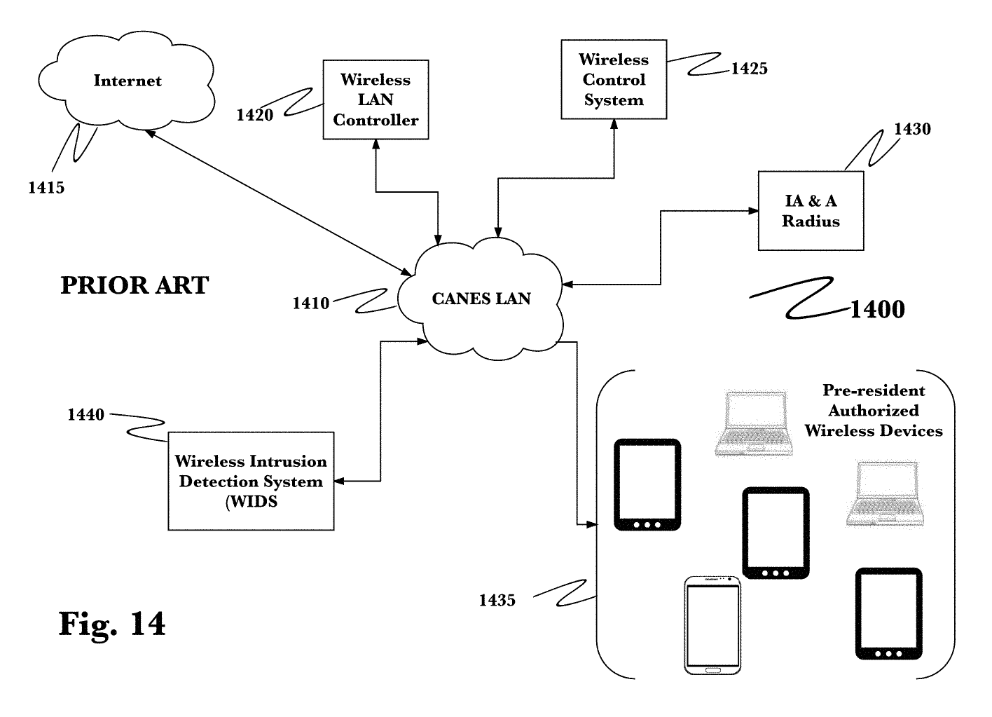

FIG. 15 shows an exemplary 3G-only architecture according to an embodiment of the invention.

FIG. 16 shows an exemplary sandboxed WiFi architecture according to an embodiment of the invention.

FIG. 17 shows an exemplary CANES-integrated architecture according to an embodiment of the invention.

FIG. 18 is a block diagram illustrating an exemplary hardware architecture of a computing device used in various embodiments of the invention.

FIG. 19 is a block diagram illustrating an exemplary logical architecture for a client device, according to various embodiments of the invention.

FIG. 20 is a block diagram illustrating an exemplary architectural arrangement of clients, servers, and external services, according to various embodiments of the invention.

FIG. 21 is another block diagram illustrating an exemplary hardware architecture of a computing device used in various embodiments of the invention.

### DETAILED DESCRIPTION

The inventor has conceived and reduced to practice, in a preferred embodiment of the invention, an integrated military mobile work information management system.

The inventor has conceived, and reduced to practice, a system for accurate and detailed modeling of systems with large and complex datasets using a distributed simulation engine.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Detailed Description of Specific Embodiments

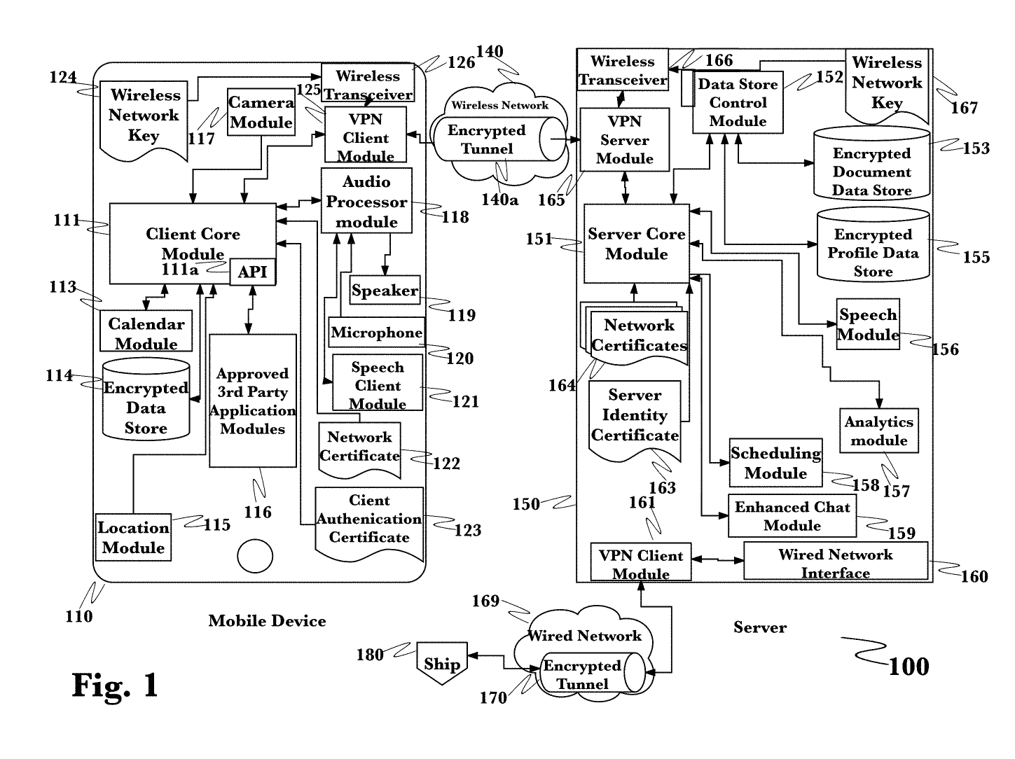

FIG. 1 is a block diagram illustrating an exemplary hardware architecture of the workforce information system according to an embodiment of the invention 100. The integrated military mobile work information management system is comprised of three major parts, at least one military mobility server 150, a plurality “bring your own wireless devices,” usually Android or iOS driven tablets, with a military approved, encrypted data storage area 114 and apps specifically designed for mobile work conditions using mobile devices that comprise the military mobile client 110. These two parts communicate through an encrypted VPN tunnel 140a over a wireless network 140 which allows military mobile client 110 and by extension serviceperson owners to securely communicate with the military mobility server 150 from any location within range of the wireless network 140. To this end, the military mobility server has significant resources dedicated to secure communication such as a server identity certificate to unequivocally prove the origin of all communication issued from it 163, network certificates and a VPN Server to prevent man-in the middle eavesdropping or data hijacking 164, 165 140a and the wireless network 166, 140 is key protected 167. The military mobile client 110 has similar, complementary measures employed having a client authentication certificate 123 that not only identifies the mobile client, but also relies on the entry of the correct serviceperson's password and thus helps insure that the designated person is seeing and data received. Further the VPN tunnel is maintained 125, 140a as are the network and protocol security measures 122, 124. Network security is, by necessity, an evolving endeavor. Protocols, technologies and practices thought safe for the long term just years ago have been made ineffective. Wireless network security is especially sensitive. The mention of specific protocols and methods here should not be seen as limiting in this area for the invention as it is not inherently dependent on any specific network technology, protocol or practice and may adopt new ones as they are developed or necessary.

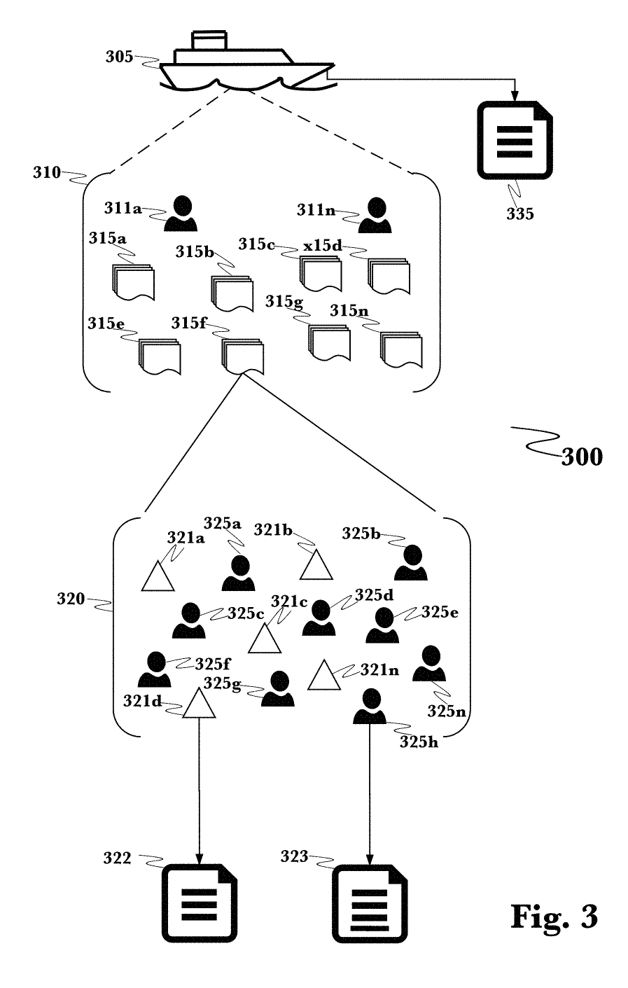

The core functionality of the military mobility server is controlled by the server core module 151 which serves as a hub for all data that passes into and out of the system and ensures that all incoming out going data are intact and transformed into the optimal format for intended subsequent use. The majority of the data entering the server core module 151 is destined to be stored in encrypted profile data store 155 as records attached to a specific profile for the ship, a structure within it of a personnel member as data all items inanimate and living are organized by profile as further described in FIG. 3 as an efficient method to encapsulate rapidly expanding information attaching to defined subjects. Either relational SQL type or some key-value database type may be used for this purpose. These data records are encrypted and access controlled by server core module 151 and a data store control module 152 to discourage information theft. The data store control module 152 also insures timely and proper storage of the incoming transformed data stream. The military mobility server may also serve as repository for all training, technical and repair references all of which may be stored in a secure document type database 153 which may have very strict access granting protocols governed by the data store control module 152 and server core module 151 to help prevent unauthorized and unrecorded retrieval of at least a number of the documents stored. Much of the ship's personnel daily activity are made up of tasks such as but not limited to the training, drill, maintenance, work center meetings, possibly repair jobs of their watches. At least a portion of these activities both individual and in groups must be coordinated and scheduled for each personnel such that each person is where they need to be at particular times, all needed maintenance and repair is accomplished prior to established deadlines and individuals have and are reviewing the correct training or PQS qualification materials to accomplish pre-defined goals prior to assigned deadlines. The scheduling module 158 in conjunction with the server core module 151 are responsible for providing the correct data to the calendar module 113 of each personnel's military mobile client to accomplish this task. The server core module may also assist in insuring that all personnel have correct access rights granted for and materials in the encrypted document data store 153 which are needed for the mentioned activities through use of the enhanced chat module 159 to send granting requests to commanding officer's military mobile devices 110, 128 for secure electronic signing approval using an efficient interactive alert chat screen that allows the recipient to complete a task without opening additional apps, even if such a requirement may be otherwise present. These activities may also make use of the analytics module 157 and the outcome of them including schedules, deadlines, task progress, document access rights and the granting of access may all be stored in the profiles of the respective parties or items on the encrypted profile data store 155. The system is designed to allow information input in the most expedient manner. Recently, centralized speech recognition, speech to text conversion and text to speech conversion systems such as SIRI™, ALEXA™, CLOUD SPEECH™ and GOOGLE SPEECH™ have matured to the point of general usefulness. The system allows for the use and capture of information from spoken interaction using the speech client module 121 on the military mobile client 110 and the speech module 156 of the military mobility server 150 which hosts the majority of the speech recognition functions.

The system also has a second network connection 160, 161, 169, 170, which would most likely be wired but may be wireless and which may the military mobility server 150 to other systems on the ship. Such a connection may allow the military mobility server to send and retrieve information from other ship's servers which may include, new training requirements to schedule, information concerning new personnel, information concerning ship equipment or status, personnel removal notices, in which case, information concerning the leaving personnel may be sent for inclusion with their transfer. Such a connection may also allow the military mobility server 150 to interact or integrate with an existing CANES wireless network 1400.

The military mobile client 110, in addition to the modules already described, has driving modules for inherited purpose-useful components of most mobile devices. The military mobile client 110 thus includes a camera module 117 to for example, allow the inclusion of images of operations effecting events discovered aboard ship or to read barcodes or QR codes that may be associated with shipboard structures or equipment when filing reports. There is also an audio processor module 118 to enable use of both the microphone 120 and speaker 119 in official communications. There is also a location module 115 that enables reading of such location and movement information as GPS signals, accelerometer data, wireless access point identification beacons and signal strengths, all of which may aid in pinpointing a service person when needed. All functions are controlled by a client core module 111 which includes a robust application programming interface (API) 111a allowing 3^{rd} party applications which may or may not be currently written to access the military mobile system and may or may not be present 116 on a specific military mobile client 110.

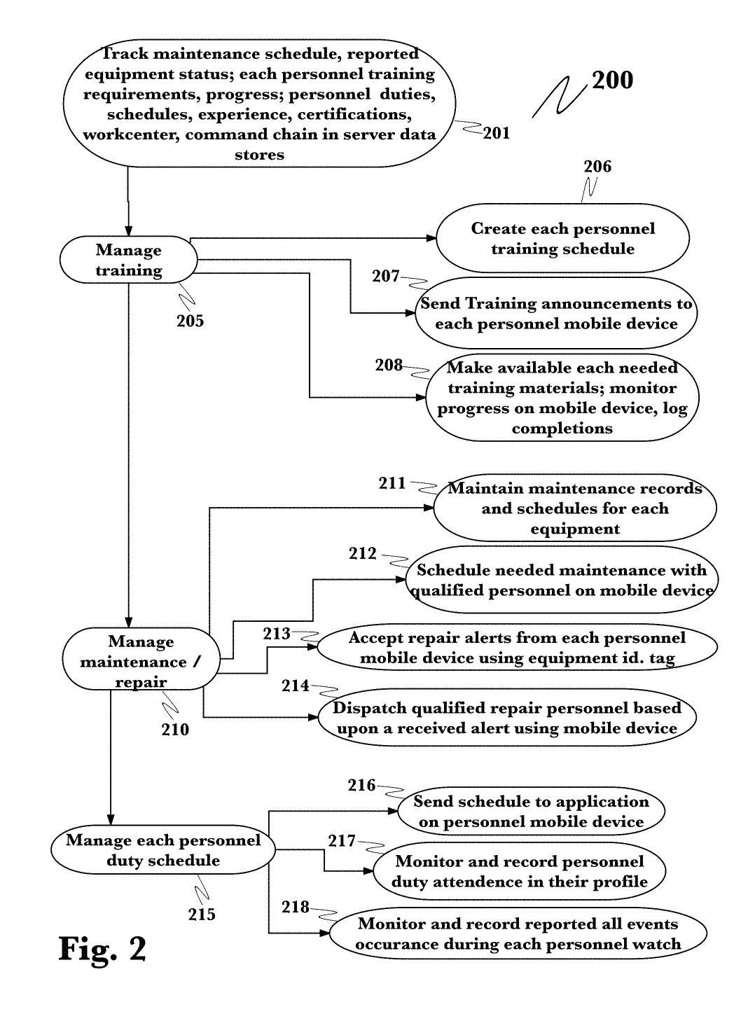

FIG. 2 is a flow diagram illustrating exemplary function of the system according to an embodiment of the invention 200. The function of the system is to track and manage several aspects of ship operations that include both the equipment present and the ship personnel present 201. Non-exhaustive examples of these functions are tracking the maintenance schedules and requirements of all shipboard equipment and assist to have that maintenance done according to predesignated schedule for each piece; track and record all equipment status reports and initiate repair action on equipment reported issues, may record repair steps, parts used and repair outcome, monitor needed follow-up; track training requirements outstanding for each personnel, schedule training periods and track progress; and maintain each personnel duties, watch schedules, work experience, certifications, work center affiliation, and ship command chain 201. In the area of personnel training management 205, the system may create a training schedule for each personnel based upon current training requirements and personnel training history 206. The system may send scheduling announcements in the form of calendar related alert text messages and personnel mobile device calendar entries 207. In an environment where many documents contain information in need of tight access control, it may occur that materials needed for personnel training, among other tasks, are not accessible by one or more trainees. The system uses analytic logic to determine each personnel, if any who need access granted to materials required by them for tasks such as a specific training module and issues granting requests, either permanent or time limited to commanding officers with ability to grant such access to the needed documents 208 electronic alerts sent to the trainees when access is granted. Many of the materials, being electronic are downloaded directly onto the trainee's military mobile client 110 and stored in the encrypted data store 114, while others are read from the server as needed 150, 153. The system may also monitor each personnel progress in reading documents and other training factors for both easy assessment by the trainee as well as by commanding personnel on their own mobile devices 110. Completed training modules as well as possible resulting certifications are then automatically and persistently stored in each personnel's profiles on the military mobility server 150, 155. These steps are used as examples of those possible and are neither all obligatory or limiting. Other steps or sets of steps may be known to those skilled in the art and the system may follow some or all of those steps dependent on the circumstances.

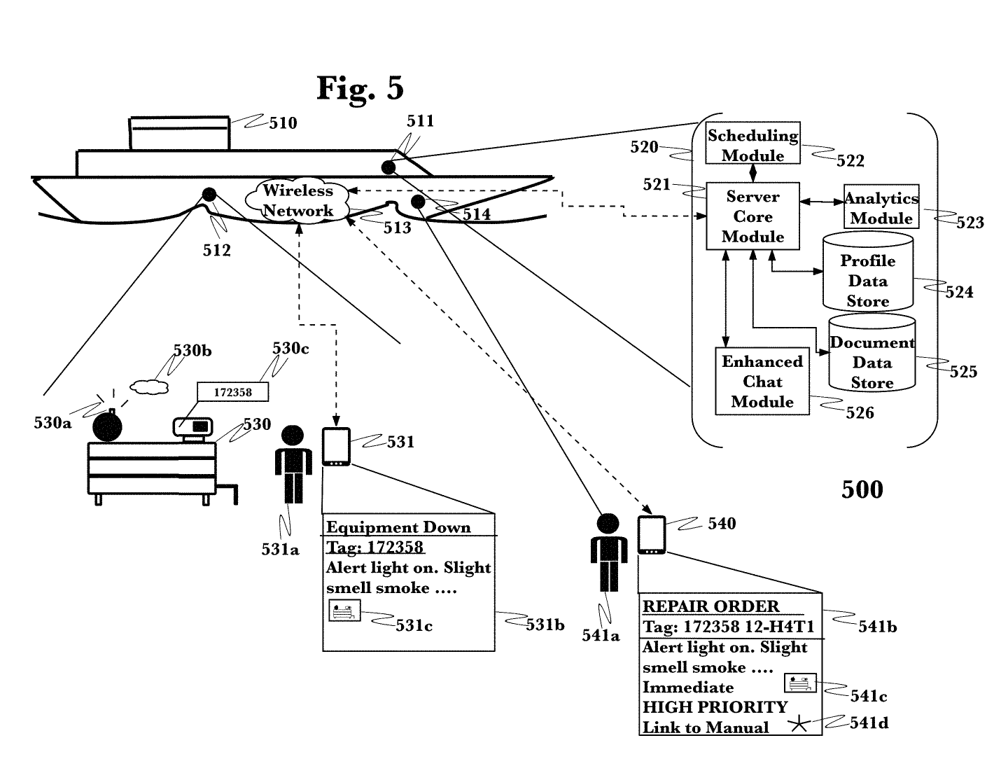

Maintenance and repairs are managed 210 using steps that may be comprised of those listed below. The system maintains profile data structures for all shipboard equipment, including a master profile for the ship proper FIG. 3. Part of each equipment profile are records for each maintenance activity performed on that equipment 211. Records comprising the maintenance schedule requirements are also kept. The system thus may schedule maintenance tasks on the military mobile client 110 calendar 113 of qualified personnel to fulfill maintenance requirements 212. As with all apps written for the system, maintenance orders are designed with mobile environment and mobile workforce first and include clear instructions of the steps to be done, easy to differentiate demarcation of completed steps and links to additional information concerning procedures or equipment should it be needed. Repairs requests may be initiated by the equipment itself by self-diagnostics or may originate from ship personnel by direct observation and scan of an ID tag attached to that equipment FIG. 5. The system accepts all repair requests and stores all available relevant information 213. The system may then assist in dispatch qualified repair personnel through enhanced chat messages 159 transmitted to the personnel's military mobile client 110 and serves as a hub for progress reports, part requests and outcome summaries. As with all apps written for the system, repair orders are designed with the characteristics and requirements of a mobile environment and mobile workforce first and may include links to additional information pertaining to the equipment under repair such as but not limited to service manuals, schematic diagrams, high definition images, parts lists and past repair reports, which may update as the current repair progresses, as new information may be deemed by the military mobility server analytics to relate to current efforts. Links to much of this information may also be obtained by qualified personnel by scanning the item's barcode or QR code, while other personnel may retrieve links to lesser detail information using the same scanning process. The repair screens also offer easy to differentiate demarcation of completed steps and include mapped areas for any text entries describing the repair. Again, the steps outlined here are meant to be exemplary and should not be treated as limiting, the invention may be programmed to follow any reasonable progression using available resources known to those skilled in the art.

Management and dispersal of duty schedules for the multiple personnel may be a time consuming task with which the mobile military system may assist 215. Schedulers have easy and, if requested, graphically depicted representation of each personnel calendars on their own military mobile clients which may be combined with any relevant qualifications or experiences of each personnel to assist in getting the correct mix for a watch with minimal intractable conflicts using the scheduling module 158 of the military mobility server 150. The scheduling module then encodes the watch duty data for each personnel and sends it to a specific enhanced calendar like function 216 of the calendar module 113 of their military mobile clients 110. The system also allows for monitoring of watch duty attendance and reporting of any attendance trends such as tardiness or missed watches and send alerts prior to habitual problems, personnel may also be located or contacted during these times if carrying the mobile client device 217. Perhaps more importantly, personnel watch duty reports become a real time process without significant loss of attention as quick text reminders into the mobile watch app screen can be expanded upon later. Events during the watch may also be spoken and then speech to text converted and the use of visual images using the military mobile client's 110 camera module 117 may also be included for later analysis. Once transmitted to the mobility server 150, all of the watch note data may be tagged per pre-designed methods and then stored, thus providing possible better use of the aggregate information. The near real time arrival of multiple watch report notes, possibly from multiple watch teams, at the military mobility server 150, coupled with the analytical power of the military mobility server 150 may allow some ongoing intelligence to be gathered. Further, watch notes made by each personnel may be tagged for terms denoting experience in tasks useful to ship operations that have occurred during the watch, adding to a searchable, detailed “living resume” that may be kept attached to the data store profile of each personnel throughout their military careers 218. Rare, but possible, loss of wireless contact during a watch may mean that all watch report entries are stored in the encrypted data store 114 of the military mobile client 110 until logical wireless connection is restored. The steps outlined for duty schedule management are felt to be a representative sampling of important functions of the invention but are not exhaustive and may not occur frequently. An embodiment of the invention may perform and normal duty management related task expected by those skilled in the art.

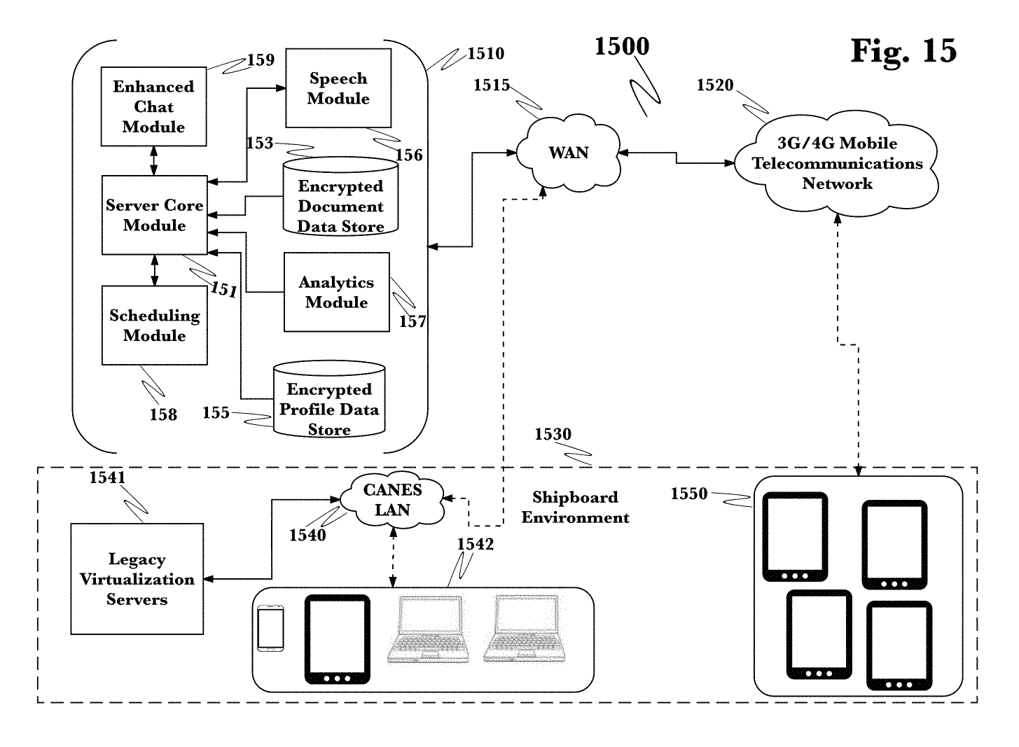

FIG. 15 shows an exemplary 4G-only architecture according to an embodiment of the invention 1500. Shown is one possible relationship between the military mobility server 1510 the military mobile clients 1550 that the server serves and the previously described CANES wireless system 1400 that is currently being deployed on Navy assets. In this embodiment, the military mobility server 1510 and all of its hosted modules, of which only the major representatives are depicted for illustrative simplicity 151, 153, 155, 156, 157, 158, 159, is physically housed off ship 1530. The military mobility server 1510 is connected to a WAN 1515 which also connects to a 3G or 4G mobile telecommunications network 1520 which provides a 4G or 3G data connection to the shipboard 4G and 3G capable military mobile client mobile devices 1550 that comprise the second part of the mobile military system (1510, 1550). As illustrated, the ship is also running a standard CANES wireless LAN 1540 with its legacy virtualization servers 1541, and dedicated mobile devices 1542 which are housed shipboard 1530. The CANES wireless LAN system also connects to a common off ship WAN 1515 but in this case, there is no reason that the two wireless systems need communicate directly. The figure points out however that the two systems may co-exist in the same band space without conflict.

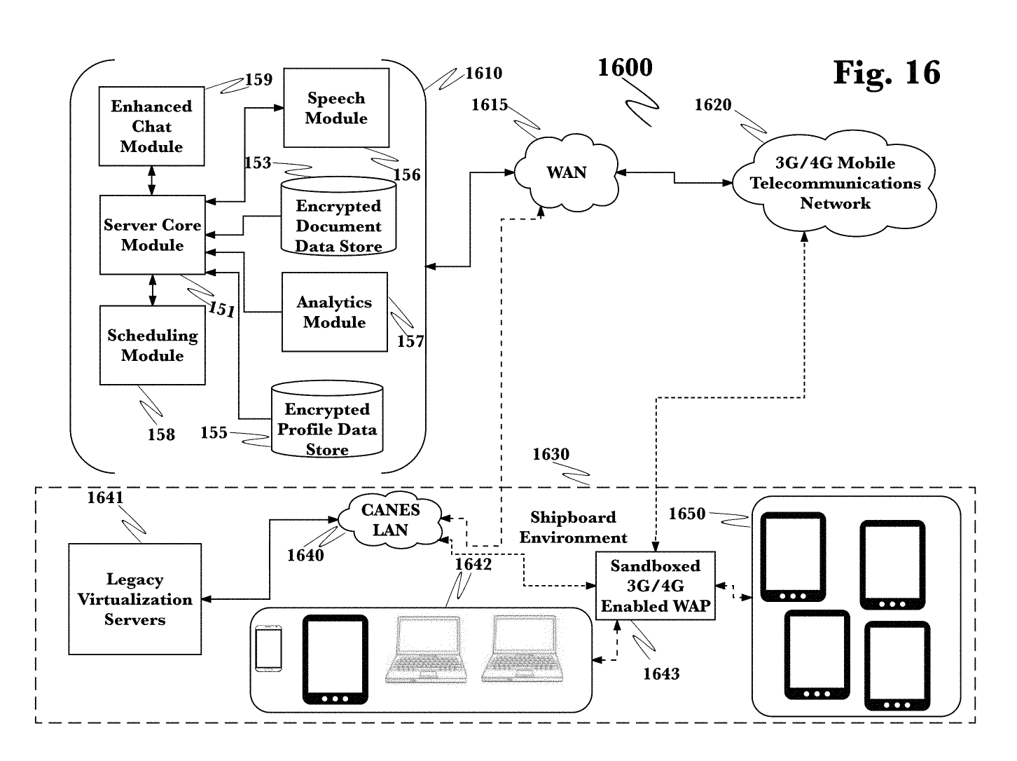

FIG. 16 shows an exemplary sandboxed WiFi architecture according to an embodiment of the invention 1600. Shown is another possible relationship between the military mobility server 1610 the military mobile clients 1650 that the server serves and the previously described CANES wireless system 1400 that is currently being deployed on Navy assets. In this embodiment, the military mobility server 1610 and all of its hosted modules, of which only the major representatives are depicted for illustrative simplicity 151, 153, 155, 156, 157, 158, 159, is physically housed off ship 1630. The military mobility server 1610 is connected to a WAN 1615 which also connects to a 3G or 4G mobile telecommunications network 1620 which provides a 4G or 3G data connection to a sandboxed 4G and 3G capable wireless access point (WAP) 1643. Shipboard WiFi enabled military mobile client mobile devices 1650 that comprise the second part of the mobile military system (1610, 1650) connect to the sandboxed WAP 1643. As illustrated, the ship is also running a standard CANES wireless LAN 1640 with its legacy virtualization servers 1641. Here the CANES LAN 1640 connects to its dedicated mobile devices 1642 through the same sandboxed WAP 1643 as the military mobile clients 1650. The CANES wireless LAN system also connects to a common off ship WAN 1615 but in this case, there is no reason that the two wireless systems need communicate directly. The figure points out however that the two systems can co-exist using some of the same wireless equipment without conflict. Of course 3G and 4G capable military mobile clients 1550 can still directly communicate over that wireless network.

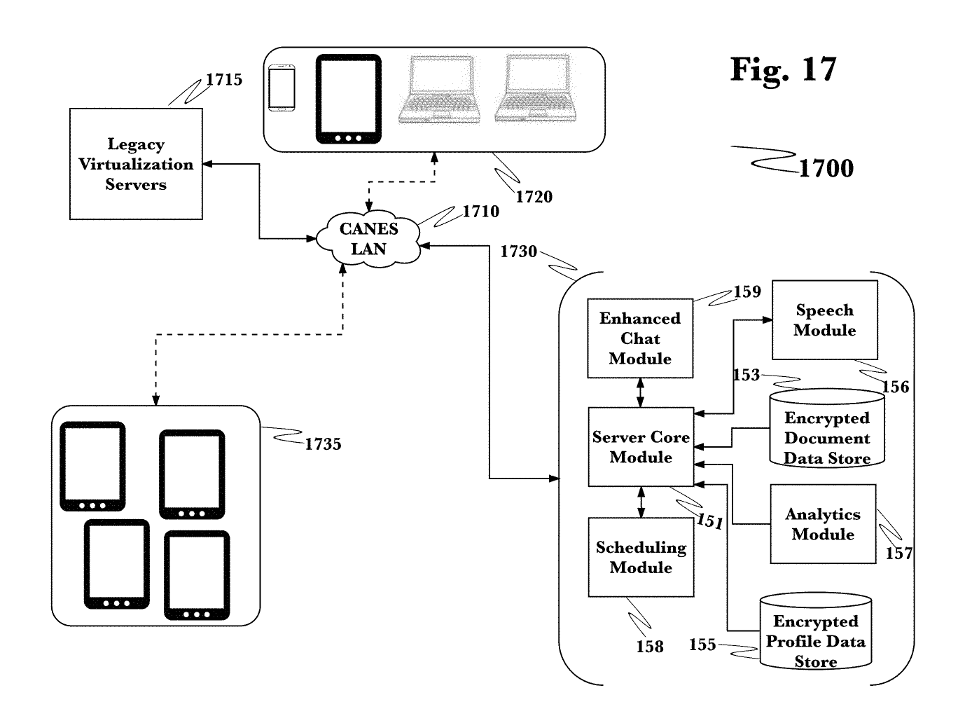

FIG. 17 shows an exemplary CANES-integrated architecture according to an embodiment of the invention 1700. Shown is another possible relationship between the military mobility server 1730 the military mobile clients 1735 that the server serves and the previously described CANES wireless system 1710 that is currently being deployed on Navy assets 1400. In this embodiment, both the entire military mobile system 1730, 1735 and the CANES LAN 1710, 1715, 1720 are deployed shipboard. Here the military mobility server communicates to the military mobile clients 1735 over the CANES LAN 1710. In this way, from a wireless network control system perspective the two systems are integrated without conflict.

Besides these three examples, others may exist which are not shown for brevity, as one possible example of multiple examples, the military mobility server is designed to be modular, so, some of the modules such as the scheduling module 158, enhanced chat module 159, and encrypted profile data store 155 may be shipboard while a server with the speech module 156, analytics module 157 and encrypted document data store 153 may be housed off ship, both having a server core module to coordinate functions. Other groupings are, of course possible.

FIG. 3 is a method diagram showing storage organization of ship component related information including personnel using profiles according to an embodiment of the invention 300. The system uses a profile model to attach data to the objects of a ship both living and inanimate, including the ship itself 305. Such a ship wide record 335 may have information such as, but not limited to: identifying information such as class, date of manufacture, designation and the like, current ship readiness status, past ship readiness statuses by date, personnel posts vacant, equipment currently under repair, general personnel training status, ports visited and events during those visits, upcoming maintenance scheduled, upcoming maintenance not-yet scheduled among many other things. All of this information can be transformed and presented in tabular format or graphically as needed for the desired application. Much of the ship level profile information relies on stored profile information from organizational layers below ship level, links to that information may be provided and may be easily found or transformed and summarized as pre-determined to provide more detail for a specific aspect of ship operations.

Below the ship level an example of the use of profiles to logically attach information may be the work center level 310 where the profile of each work center 315a, 315b, 315c,315d, 315e, 315f, 315n has an attached commanding officer 311a to 311n who herself 311a has a personnel level profile, but a work center itself 315f in made up of all equipment and personnel assigned to that zone and a work center profile 320 thus made up largely of references to the profiles for multiple pieces of equipment 321a, 321b, 321c, 321d, 321e 321n and personnel 325a, 325b, 325c, 325d, 325e, 325f, 325g, 325n, although some information pertaining to the work center as a whole such as but not limited to group qualifications, main function, station area, and accomplishments may be stored. The profile 322 of individual equipment 321d may contain such data as age, age on ship, work center affiliation, maintenance requirements, maintenance schedule, maintenance completed, repair history, parts replaced, and scheduled replacement date, if appropriate, among other items familiar to those skilled in the art. The profile 323 of an individual service person 325g may contain length of service, certifications, qualifications, training completed, training outstanding, work center affiliation, task useful experiences, rank, previous posts, reviews and any disciplinary actions among other entries familiar to those skilled in the art.

The use of profiles as the organizational unit for attaching information gives rise to a hierarchical relationship within both equipment and personnel columns which is easily traversed both electronically and manually, when needed and further allows for the accurate referenced storage of continuously increasing information pertaining to profile objects.

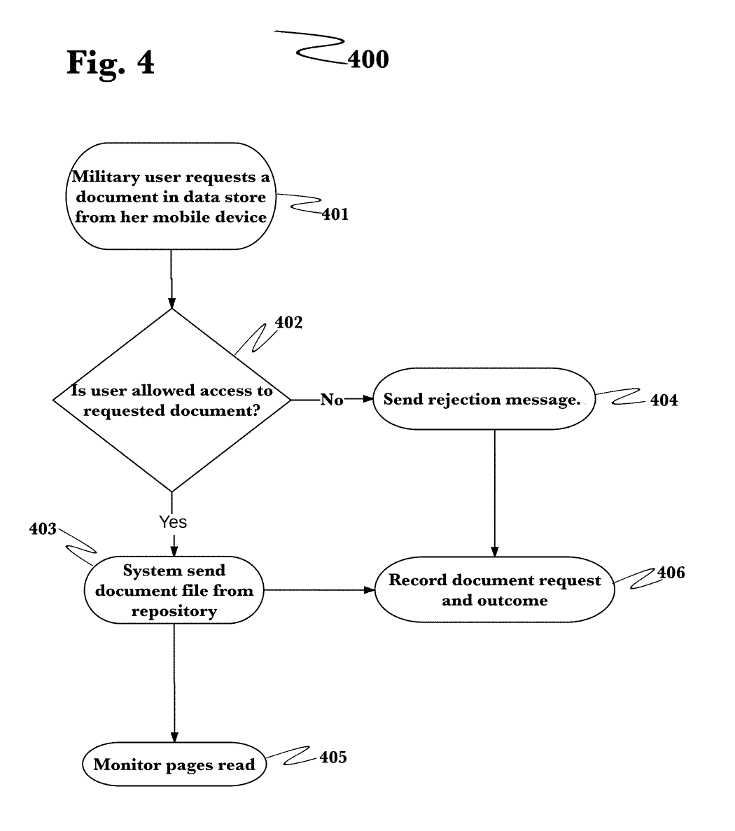

FIG. 4 is a flow illustrating library document security according to an embodiment of the invention 400. At any military installation, including ships, access control to documents is an important consideration. The system allows for this by encrypting all information and then granting access to each piece of information or document only to those personnel with specific access rights for it. When a military user requests a document in the data store from her military mobile client 401 the logic of the military mobility server 150 first determines if she has access rights for that document 402 and, if so, the system may send the document file to the user's mobile client from the encrypted document data store. Alternatively, for other documents, the user may be allowed to read a streamed copy of the document but the document's file kept on the server (not shown). A record of the document request and pages read within the document are kept as part of both the user's and document's profiles 405, 406. There are times when a user may request a document for which they do not have access clearance 402, under these conditions the request is recorded in the profiles of the user and the document 406, and a rejection message that may contain instructions for how the user may have access granted may be included. For certain documents the system may also be programmed to issue alerts concerning failed access attempts.

FIG. 5 is a system diagram showing the repair request cycle for shipboard equipment according to an embodiment of the invention. While a plurality of repair requests may be generated at the military mobility server 150 due to failed equipment self-diagnostics for systems monitored directly, many will originate from users, either working with that piece of equipment 530 as part of their duties or passing by equipment 530 by chance at its location 512 and noticing something believed wrong, who then use an app 531a for the purpose on their military mobile client 531. Under the system, such users would first scan the identifier tag 530c permanently affixed to the piece of equipment, which will open the repair request with references to that item and may send a confirmation image to the mobile device user to positively identify the item. While the digits 172358 are used in this example, such a representation is cumbersome and not machine friendly. While possible that numeral digits be used, especially if other means fail, it may be more likely that a bar code or QR code would be scanned instead of numbers scanned or manually entered. The repair request e-form 531a, may have a menu driven title to denote severity, confirmatory information about the equipment item and then freeform or menu driven descriptive text for the observed issue. Images 531b and short sound recordings may be allowed to convey physical characteristics such as an alert light flashing 530a, the presence of smoke 530b or noises being made by the equipment that the reporter believes unusual. All repair requests sent wirelessly from the site to the mobility server 150 might then be addressed wholly by the system with its analytics capabilities 523 used to correlate current conditions to previous ones and data store recorded personnel profiles 524 and to schedule information 522 being used to dispatch qualified repair respondents, or dispatch of repair personnel may be handled in conjunction with command personnel where the system recommends a course of action and a number of responders and the course of action and responders chosen by command personnel. Regardless, responders may be dispatched wirelessly 513 from anywhere on the ship 514 from the server 511 through a repair alert on their military mobile clients 110, 540 with an alert that contains the identification, exact location and possible current image of the item 541a, 541b and links 541c to such information as the item's service manual from the encrypted document data store 525, repair history, and maintenance history from the item's profile 524 along with other important information known to those skilled in the art. As an enhanced chat module enabled e-form 525, the repair request may also be used interactively to text chat with other support personnel, order needed parts by calling up another enhanced chat enabled e-form, or contact the incident reporter, to name a few example interactive choices. All notes made on the repair related e-forms during the repair are aggregated, possibly transformed by the system and persistently stored attached to the equipment item's profile. This scenario is just one of many imaginable that may arise in a repair situation. The example should not be interpreted as limiting the invention to a particular set of events as the invention is capable of responding to and acting upon a wide range of possible event progressions.

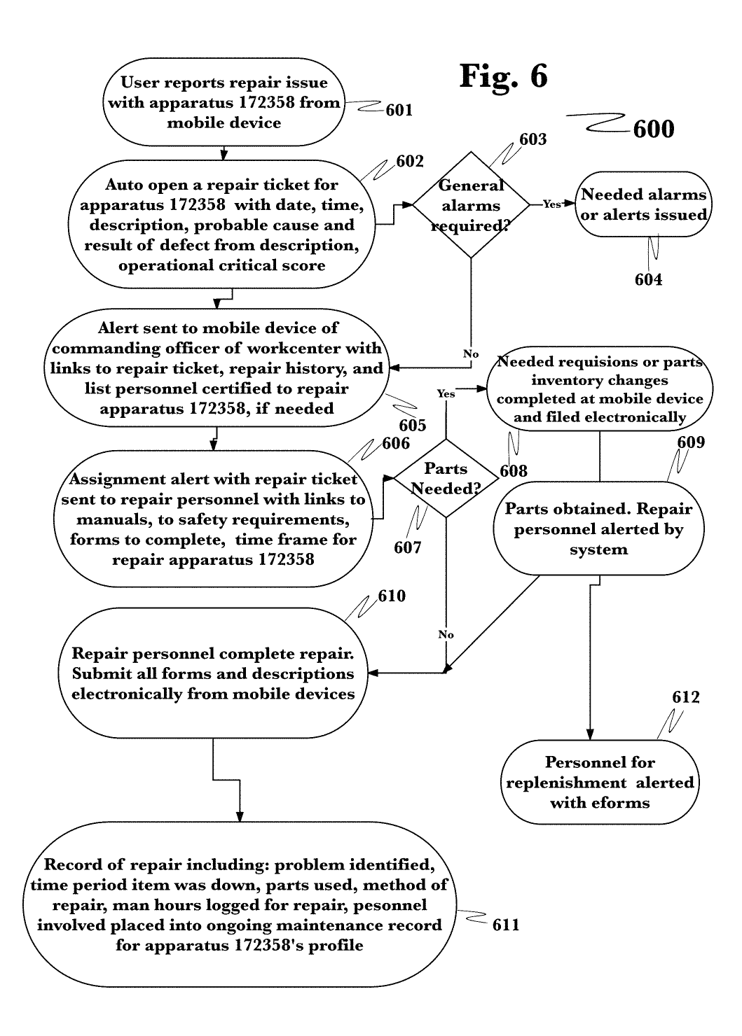

FIG. 6 is a flow diagram showing steps on the repair request cycle for shipboard equipment according to an embodiment of the invention 600. A repair request is initiated when a user opens the repair app on her military mobile client 110 and scans an equipment identification tag found on the item in need of repair 601. The system then opens a repair record for the identified equipment and may send a confirmation image to the user. The user is then encouraged to describe the issue observed and may include images and short audio clips if felt helpful, which are interpreted by the system for severity, with operational critical level also determined by the equipment involved and the danger posed 602. The system may then determine 603 to activate pre-determined as needed alarms and send out alerts based on analytical appraisal of the situation 604. Regardless, repair request alerts that include the equipment identification, links to maintenance and repair history, links to service manuals and a list of qualified repair personnel may be sent to the military mobile client of specific command personnel responsible for the equipment involved 605. Personnel to complete the repair can then be chosen from the list based upon criteria which may include but not limited to schedule, and experience present on the repair candidate′ “living resume” record. Similar, but more detailed information which may additionally include safety information, electronic forms to complete and a target repair time frame if not immediate, may then be sent in an interactive repair request to the designated personnel 606. The repair app imbeds an enhanced chat engine that allows communication with other experts or the event reporter when needed and also is able to open imbedded parts request electronic forms without the repair user having to switch between multiple apps during the process in addition to other repair related capabilities when needed 607, 608. In the event that the needed part is not immediately available the system may track part delivery progress and auto reschedule the repair completion 609. Similarly, if inventory of a frequently needed or critical part is brought below a pre-designated minimum by the repair the system may alert responsible personnel of this development through their mobile devices so that replacements are ordered in a timely manner 612. All information concerning the repair which may include but is not limited to the original problem identified, the time period the item was down, parts used in the repair, man hours spent in the repair and the personnel involved in the repair is stored in the equipment profile and referenced in the repair personnel profiles, possibly in a transformed or aggregated form as per the requirements of the situation 610, 611.

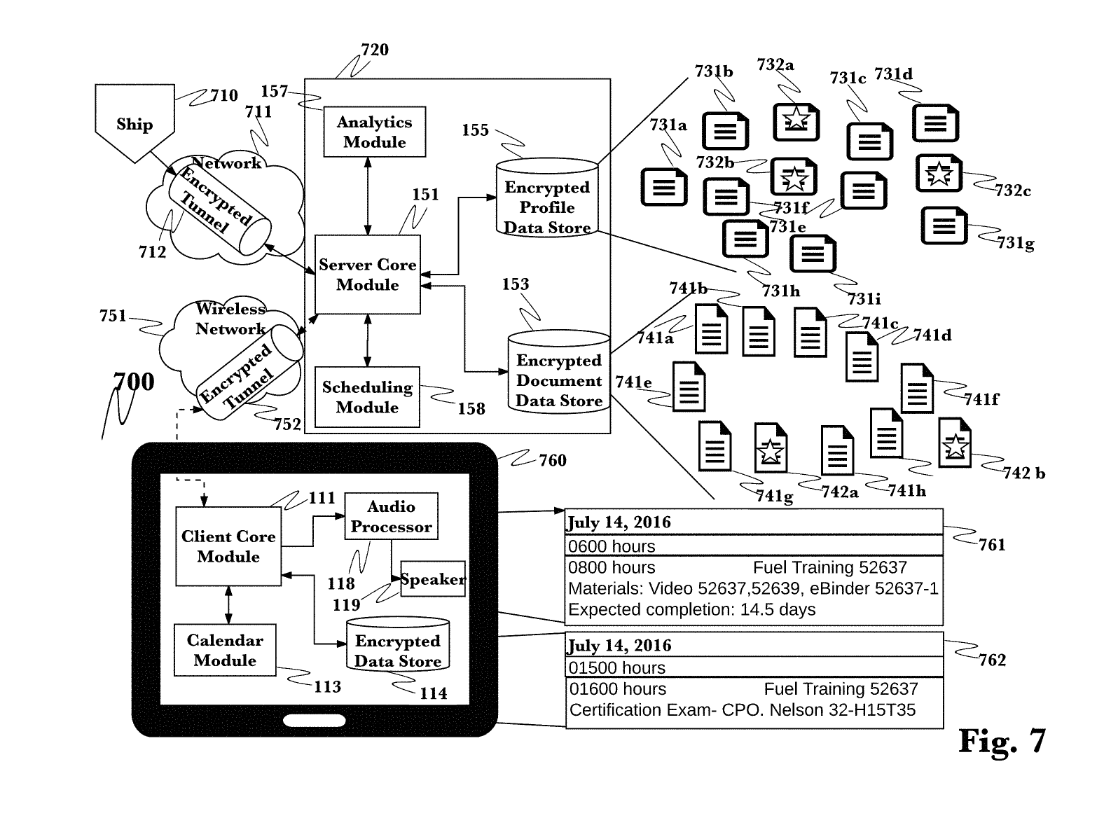

FIG. 7 is a system diagram showing automated scheduling of required workforce personnel training and certification modules according to an embodiment of the invention 700. Keeping up-to-date on newly mandated training and the training needs and progress of new arrivals may be time consuming. These tasks are well suited to modern computer information technology and analytics. In one possible embodiment of the invention, training requirements and the current profiles, which includes training completion information, of new arrivals on a ship is received or retrieved from other systems on the ship 710 over a VPN encrypted network 711, 712. This information is first persistently stored in the encrypted profile data store 155 of military mobility server 720, and is then used by the programming of the server core module 151 and the analytics module 157 to determine the training requirements of each personnel. For a specific training module there will be a number of personnel who have completed that training 732a, 732b, 732c which is reflected within their profiles 732a, 732b, 732c while others will still need to either take the module or complete it 731a, 731b, 731c, 731d, 731e, 731e, 731f, 731g, 731h which again is reflected in their profile 731a, 731b, 731c, 731d, 731e, 731e, 731f, 731g, 731h. This information is used by the system to schedule personnel for training using the scheduling module 158, which also accounts for all entries already on the service person's other calendars. The system 720 also may initiate the process to supply each personnel with the materials needed for their training schedule 742a, 742b which may involve issuing access grant requests to commanding officers for those documents. The training calendar of each personnel is eventually securely updated wirelessly 751, 752 through interaction between the military mobility server's 720 scheduling module 158 and the military mobile client's 760 calendar module 113. Training materials may be stored locally on the mobile device's 760 encrypted data store 114 or may be streamed from the server 720 on demand depending on security and other factors. Callout 761 shows an example training calendar entry specifying the training module, the materials needed to complete the module and the timeframe allowed for completion. The system may monitor a service person's progress through those materials. Callout 762 shows a co-scheduled training calendar appointment for a certification examination indicating the exact location and the person conducting the exam. The capabilities illustrated here are for illustrative purposes and are therefore simplified. They are not the entire repertoire of the invention and should not be used as limiting the inventions capabilities to just those tasks.

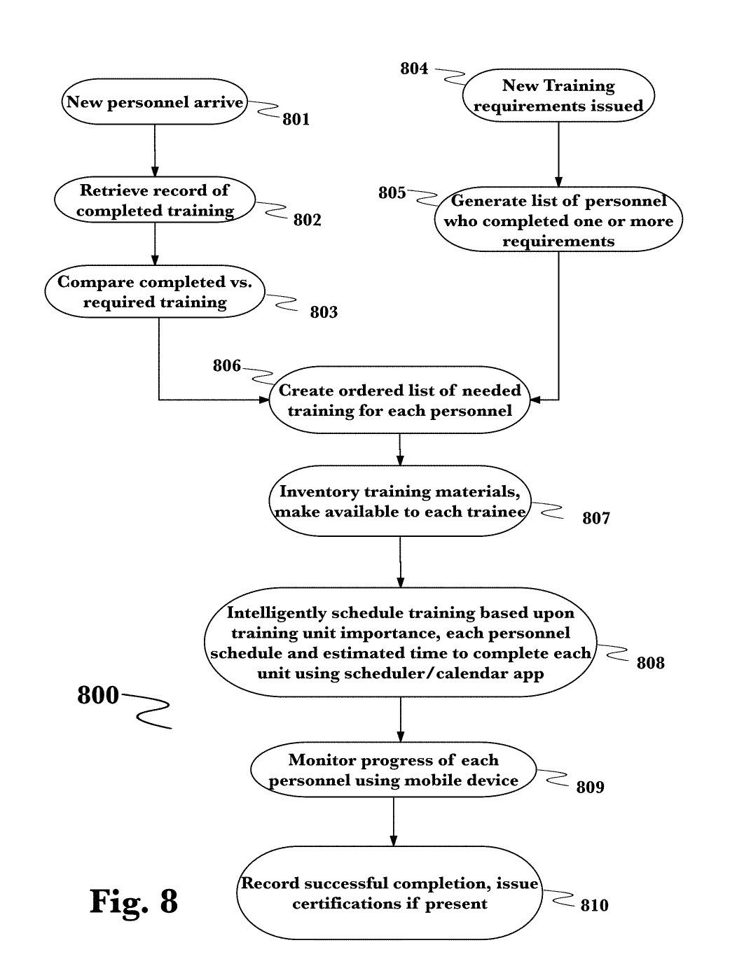

FIG. 8 is a flow diagram showing steps involved in automated scheduling of required workforce personnel training and certification modules according to an embodiment of the invention according to an embodiment of the invention 800. Two major training circumstances are foreseen, the arrival of new personnel to a ship 801 and the implementation of new training specifications which may affect all personnel on a ship 804. Both circumstances eventually require similar resolution steps and result in the same outcome and so are combined here. In the case of new arrivals, the embodiment will first retrieve the list of all training completed by the new arrivals 802 for comparison against the ship's training requirements 803 from their transferred profiles. In the case of new training requirements being implemented, in some cases a group of the ship's personnel may have completed one or more of the training units for some other reason and that information found in their profiles 805 those individuals can then be released from those units. In all cases a list of outstanding required training units may be generated 806 and steps initiated to make available all materials needed for the planned training to the affected individuals 807. The system may then schedule assignment and completion of training units accounting for each personnel's work and other calendars placing training unit information on the personnel's mobile device calendars through interaction between the server's scheduling module and the mobile device's calendar module and graphical calendar app frontend 808. The system may also monitor progress of personnel through their training units by monitoring their progress through the training materials 809. Finally, upon successful completion of training units, completion notation and certifications earned may be added to each personnel's persistent electronic profile 810. Commanding officers may also be alerted through their mobile devices and paper certificates requested.

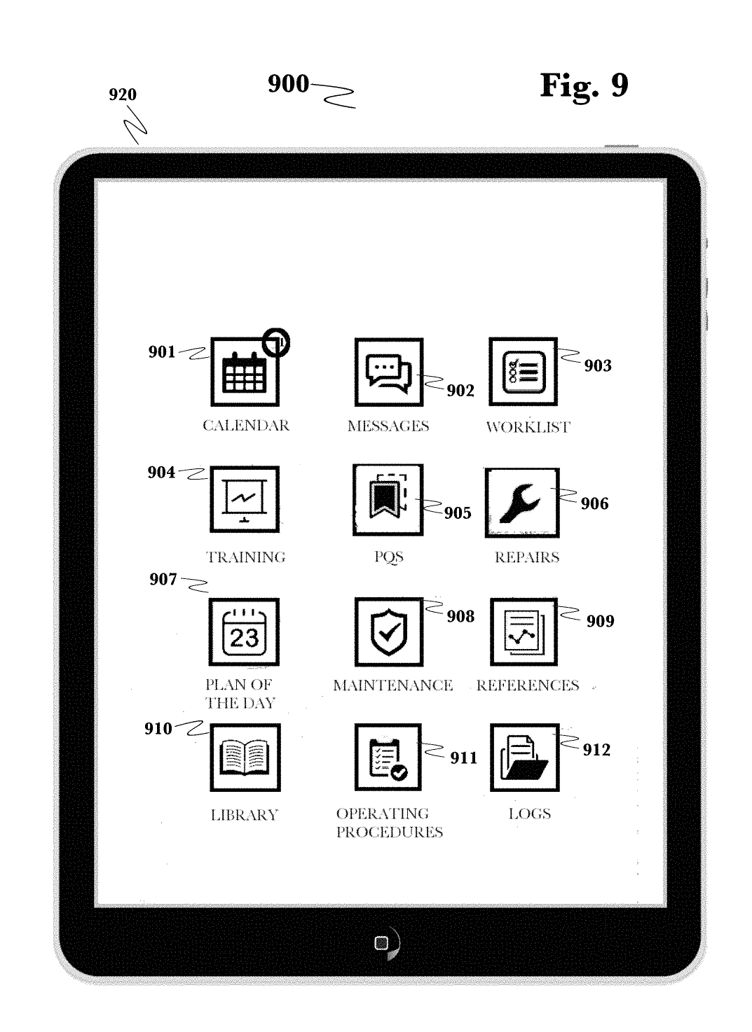

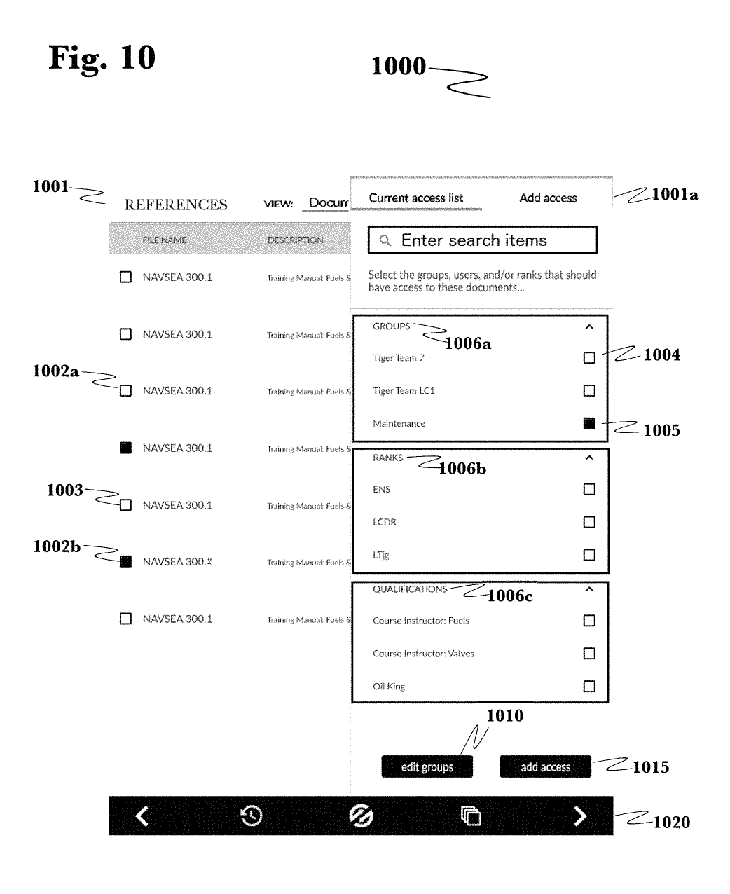

According to a preferred embodiment of the invention, an integrated shipboard mobile work management system, is disclosed. FIG. 9 shows a notional main app selection screen of a system capable of providing a set of mobile-first, hyper-focused enterprise apps for the work military personnel actually do in mobile environments (such as aboard ships and in the field), integrated into a powerful platform with a rich data analytics layer. The platform brings consumer level joy of use to a Gen X/Y workforce in an industry where the incumbents are rarely mobile, never mobile-first. Examples of apps that may be deployed in a shipboard environment on users' bring-your-own-device (BYOD) mobile devices include, but are not limited to: training schedule 904 and the personnel qualification system including audits and enforcement of qualification standards and authorized signers 905; operating procedures 911; and log taking 912; plan of the day 907, as well as integrated calendaring 901; daily worklist calendar view 903 and multicast communication from command authorities to individuals and groups of individuals throughout a ship 902; preventive maintenance system support 908; reference apps which is a group of small single purpose apps for administrative tasks 909, see FIG. 10; easy access to important documents such as equipment operating and maintenance manuals, training manuals, and tactical manuals for which the user has access rights 910.

FIG. 10 shows an exemplary document library material access maintenance screen which is found under the REFERENCES selection of the main screen, according to an embodiment of the invention 1000. Shown is the group access control screen from the dedicated access control app. As with all system apps, this screen is highly graphical and makes granting of access rights to whole specific groups of personnel easy 1001. At left is a scrollable list of available library documents 1003 and to the right a pulldown list of available groupings which may be granted access rights to the documents on the left 1001a which is broken into sections for such alternatives as named groups 1006a, qualifications 1006c and ranks 1006b, although other groupings are available but not depicted. Access may be granted by selecting a group 1005 from the group list 1001a and then selecting the documents for which access is to be granted from the document list to the left 1002b. As with other mobile client apps, for ease of use in the field, using the opposite selection order, selecting the documents first and then groups to be granted access, produces the same result. Decisions are enabled by selection of the add access confirmation at the bottom of work screen 1015. Groups can also be edited in the app 1010. Bar 1020 is the home bar and assists in moving between work screens and visualizing or returning to previous apps and may be found on all screens.

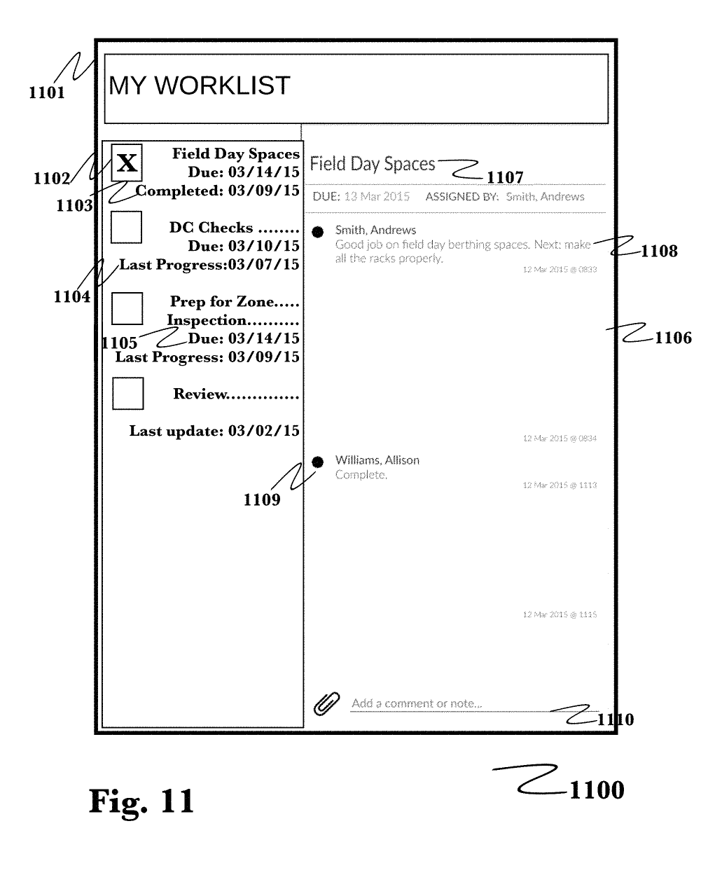

FIG. 11 shows a typical worklist task screen according to an embodiment of the invention 1100. A possible worklist app screen 1101 is shown which shows tasks assigned to the mobile device owner in the left column. The column shows a list of tasks to be completed with due dates for each clearly displayed 1105. Also indicated is the last time progress was reported toward completion of the task 1104 and indicators of completion 1102 which includes the date completed. The right side of the screen hosts a chat screen 1106 where work task items can be discussed 1108, 1109, each chat subject being displayed to prevent mis-posting 1107. Longer posts to the chat such as text files or items such as images can also be attached to the chat 1110 as found necessary.

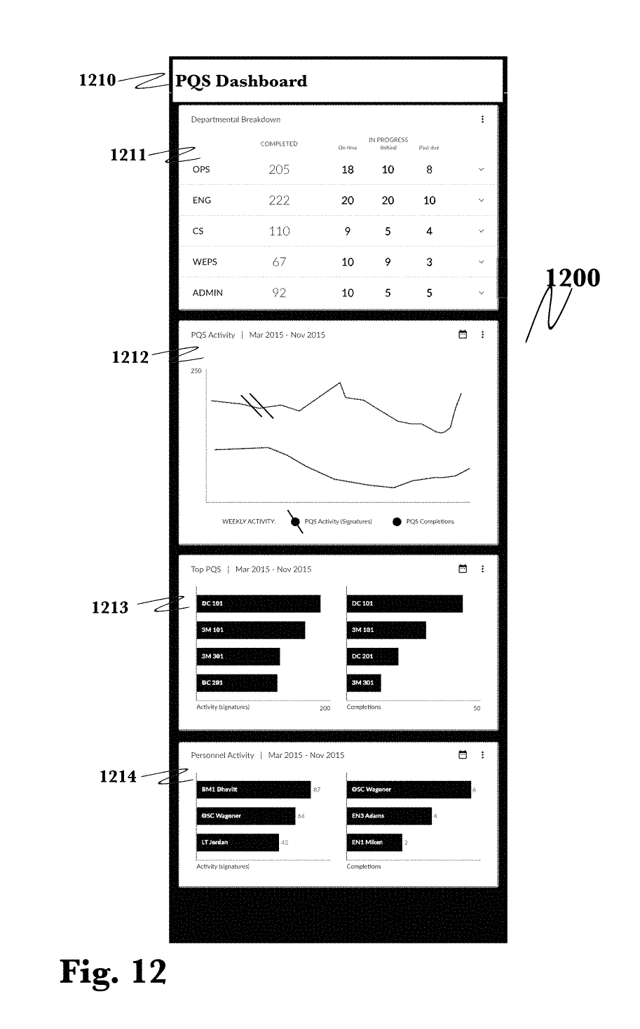

FIG. 12 shows a typical shipboard information summary dashboard screen according to an embodiment of the invention 1200. Data summaries prove invaluable in evaluating the quickly status of most operational endeavors. Shown here 1210 is one of a great many possible aggregative data summary dashboards that the system may produce, this one related to the personnel qualification standard (PQS) status on board a ship of interest. The top panel shows a tabular breakdown of PQS status by department. The middle panel 1212 shows progress toward PQS completion over a 9 month period. The bottom two panels 1213, 1214 show further PQS activity in the form of bar graphs with the lower panel showing individuals attaining the most progress towards their PQS in the previous 9 month period 1214.

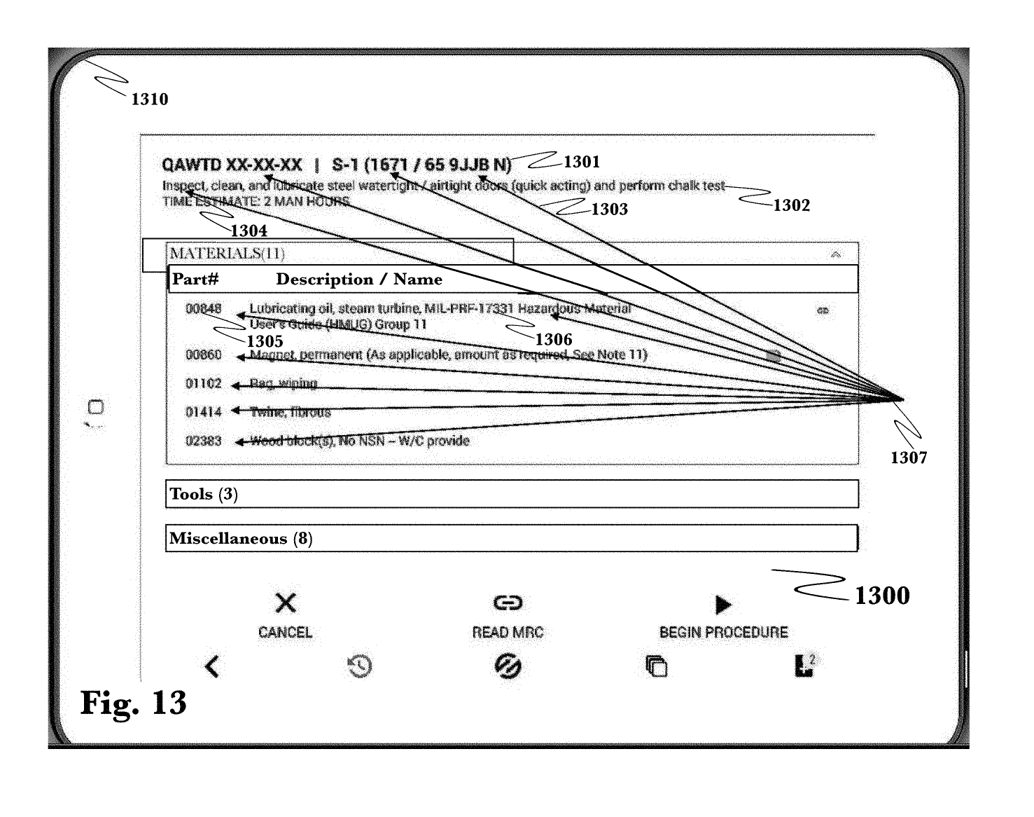

FIG. 13 illustrates exemplary system analytics mapping a sample equipment maintenance order for inclusion into equipment's profile record according to an embodiment of the invention 1300. One important aspect of the military mobile system is its ability to efficiently and meaningfully store information such that it can be intelligently combined with similar data to suggest conclusions or tie data together. These capabilities, in large part are enabled by the recognition, by the system of virtually all official designations, whether they be order and process designations 1301, 1303 part numbers 1305, and safety designations 1306 of which those displayed are but a very small subset of those known to the system. The system also has been pre-programmed to recognize a large set of environment important text words 1304 in context so that items pertaining to the actions taken and time needed to perform maintenance on a piece of equipment of repair a piece of equipment or perform other work tasks can be stored in a future usable way 1307.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

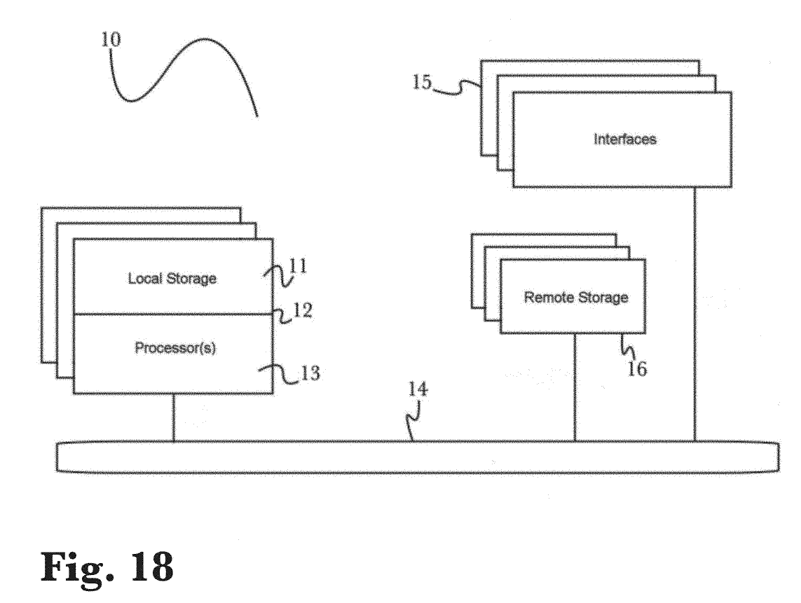

Referring now to FIG. 18, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown and described above illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

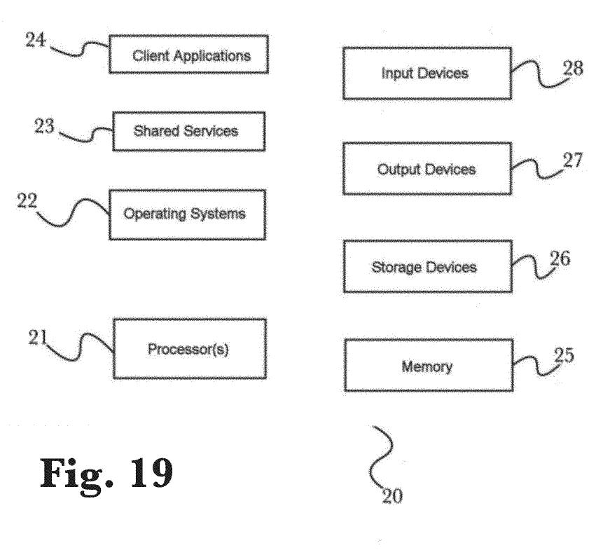

In some embodiments, systems according to the present invention may be implemented on a standalone computing system. Referring now to FIG. 19, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above). Examples of storage devices 26 include flash memory, magnetic hard drive, CD-ROM, and/or the like.

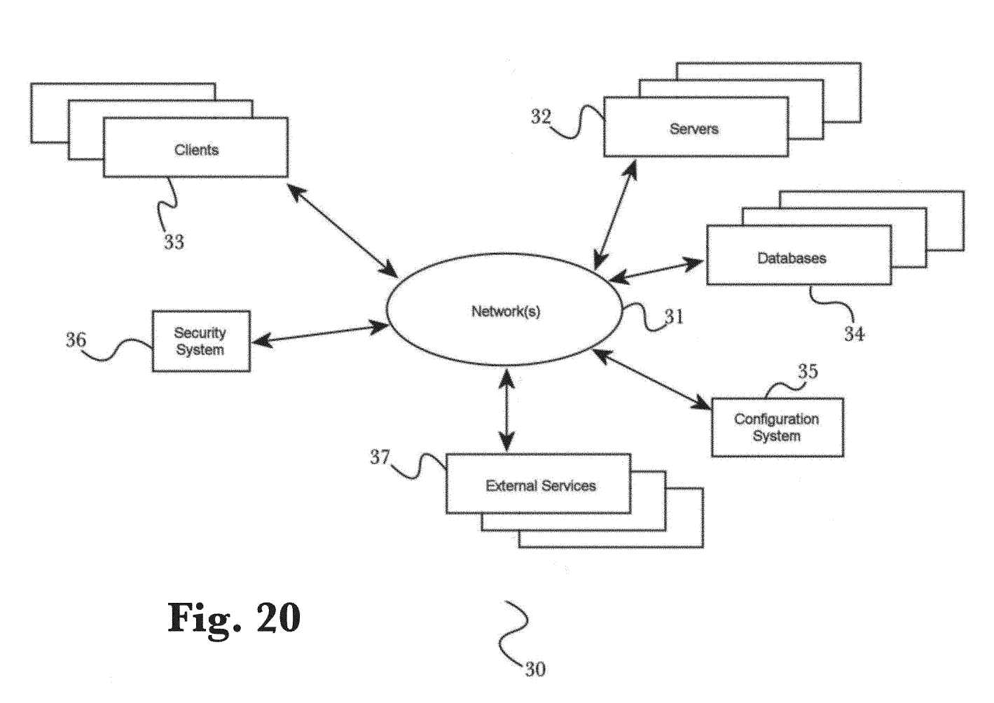

In some embodiments, systems of the present invention may be implemented on a distributed computing network, such as one having any number of clients and/or servers. Referring now to FIG. 20, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated above. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

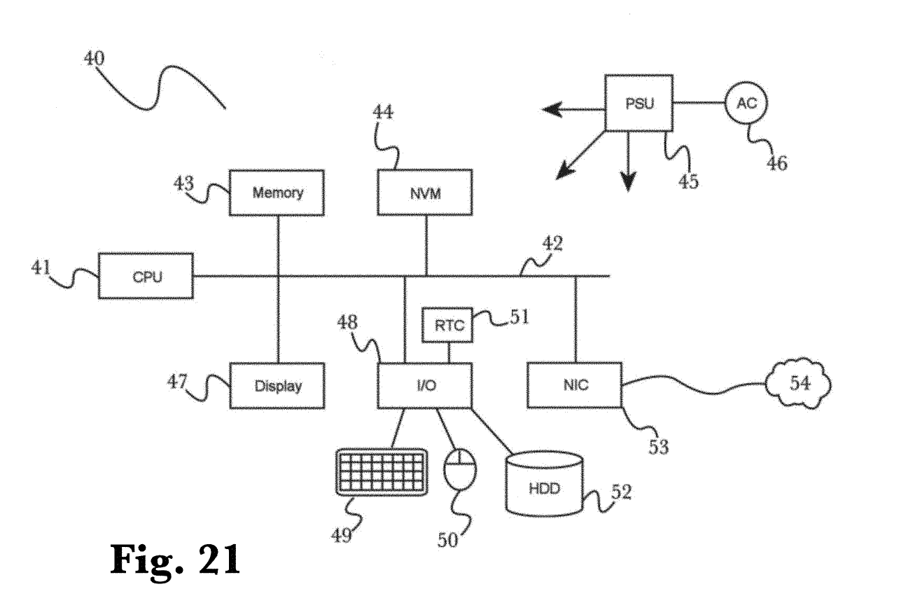

FIG. 21 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client.

It will be appreciated by one having ordinary skill in the art that the screen shots shown are merely exemplary, and should not be taken as limiting. According to the invention, a full range of mobile-first (that is, designed from the beginning to be used by mobile workers, at the point of work, on mobile devices including preferentially tablet computing devices) may be provided to sailors (and other mobile military personnel) to create a mobile work experience that is consistent with the daily non-work computing experience of young military personnel.

In some embodiments, a mobile device manager may be included with systems according to the invention. Security, including safety of personal identifying information (PII) is a principal component of the invention. It is anticipated that military mobile systems according to the invention will be integrated into existing shipboard information security architectures. For example, when available, REDHOUND™ Software (Purebred solution) using Simple Certificate Enrollment Protocol (SCEP) may be used; in this embodiment, simple certificates will function the same as CAC certificates. A NIPR connection may be used if provisioning certificates when ship is out to sea. In another security arrangement, users may download PKI certificates from DISA portal using Firefox Browser. Since such certificates will lack edipi@mil attribute, they may be used only to sign and encrypt email, since most CAC enabled sites will reject. Moreover, this approach may also require a change to Active Directory (AD), MS Exchange, and WAP configurations to accept these certificates. Thus this solution does not scale well, but is likely sufficient for pilot implementations; requires each user to download their own certificates which maybe very time consuming, and once user downloads certificates, there are two options for getting onto a CMD: manually sideload, and securely transfer to OpenTrust CMS (COTS product) and wirelessly provision to CMD.

The readiness platform of the invention is designed to make the enablers easier, faster, and more transparent, so that our sailors may focus on the real mission—war fighting.

### Daily Administration & Work

Meeting the nation's demands is becoming more challenging under current fiscal conditions. Procuring time-saving and knowledge sharing tools is essential as requirements increase, but the number of Sailors on ships stays the same or decreases. PESTO represents the pillars of shipboard readiness, however, the administrative programs that buttress those pillars are many. The invention aims to complement existing programs and modernize others.

21^{st} century systems have evolved the way people work today. Communication, real-time reporting, just-in-time tools, and collaborative worklists are the new standard within industry today. These four applications are the foundation for improving shipboard readiness and supporting PESTO pillars.

The invention is a comprehensive mobile-first integrated platform to get work done. The inventors have designed a workforce management and reporting platform with consumer-level “joy of use”, targeted initially at naval users. The invention provides a platform and a data API with a work management app suite.

Administrative SaaS Applications could Include:

| Feature | Benefit |
|---|---|
| Collaborative Worklist | Know daily priorities, less wasted time |
| ChatMC ™ | Instant shipwide communication |
| Mobile Plan of the Day | Alignment and time management |
| (M-POD) | |
| Real-Time Daily Reports | Less waiting around for signatures, |
| | data trends |

The Navy realizes current enterprise technologies are stove-piped and limit user participation, have coding standards limit information transfer, and result in big data opportunities being missed. The invention provides the solution with best user-practices for superior content management within the Collaborative Wordlist, CHATMC™ for waterfront communication; information security for a Mobile POD; and digitized paperwork for daily reports.

### PESTO. Personnel

There is a long runway to develop personnel management tools for the fleet. Existing PC-based systems are used, such as Relational Administration Management (RADM), which is the legacy program used since the late 1990s. The invention may be the backbone of the next generation of manpower tracking programs.

Personnel SaaS Applications could Include:

| Feature | Benefit |
|---|---|
| Personal Safety | Safety Petty Officers identify fix hits |
| Division Office Notebook, | No more binders, greater Sailor welfare |
| PII protected | |
| Mobile Personnel | Needed information, available at all |
| Qualification System (MPQS) | times, eSign for tracking |
| Shipboard Alerts | Sailors at the right place at the right |
| | time |
| eSailor program | Boot Camp Pilot Program |
| eDivo | NAVPERS Static App |

Key safety discrepancies go unobserved and are not tracked. Division officer (DIVO) notebooks reside in 4-inch binders and are not updated regularly to reflect sailor development. With layered security for Personal Identification Information (PII), the Mobile DIVO Notebook will improve a sailor's readiness to deploy, increase knowledge sharing on family readiness needs, and create a dashboard for tracking Sailor performance more frequently. The invention transfers paper-based PQS into a digital interface through and delivers the right information to the Sailor at the point of performance.

Readiness rests on the foundation of an effective material condition program. Effective zone inspections are required by the Standard Operations and Regulations and Manual, however, the sailors may effectively track and prioritize important discrepancies. When equipment works according to design, and sailors may effectively operate the gear, ships meet operational tasking. Self-Assessment is the first step to equipment readiness. Unfortunately, sailors lack the tools to identify, track, and repair equipment in a digital age. Shipboard personnel-Leading Petty Officers, Chief Petty Officers, and Officers—understand how to inspect spaces from legacy schoolhouse training, Surface Warfare Officer School, and waterfront “mini-camps.” However, the shipboard leaders are wasting time with paper-based systems and clipboard tracking tools.

Material Maintenance Management (3M) is also fundamental to ship readiness. In 2014, a maintenance pilot program was conducted on USS Laboon (DDG 58) with positive feedback. Sailors must quickly translate material discrepancies into an automated work request (AWR) to begin the process of equipment repair. Without the technical references—NSTMs, MRCs, or CSOSS—and parts information at the “point-of-performance,” sailors must wait to access limited computer access on ship.

Sailors must continually learn throughout their enlistment. Having technical references for planned maintenance is essential to that end. The Technical Data Knowledge Management System (TDKM) will ultimately plug in to the system of the invention to allow greater dispersion of knowledge resources. Sailors report frustration references being buried on personal computing share drives or being printed out and left in physical binders. Moreover, understanding Joint Fleet Maintenance Manual quality assurance (AQ) standards will improve the quality of equipment repairs. The invention will unlock technical resources to tap the talent on Navy ships.

Equipment SaaS applications could include:

| Feature | Benefit |
|---|---|
| Mobile Zone Inspection | Discrepancies annotated and never |
| | lost in notebooks [think EverNote) |
| 3M DigitalSpotcheckMobile | Doing is reporting, no more clipboard |
| AWRs/JSN | |
| Technical Data Knowledge | Knowledgeable Sailors fixing gear |
| Management System (TDKM) | |
| Quality Assurance thru JFMM | Less rework through QA understanding |
| ClassroomReachBack (CRB) | Reconnect with videos and virtual |
| | trainers experienced during |
| | NEC curriculum |

The invention provides a is platform for other applications to nest within. The Reliability Engineer Data Integration (REDI) application of the invention is a leader in the integration of legacy programs. With REDI technology, the importance of MilitaryMobile's ServiceGraph™ becomes central to workforce management. The ServiceGraph™ is the accumulation of behavioral data within a sailor's career and captures the overall performance of an organization. The integrated features that REDI delivers are a first step to many other integrated systems. Once these multiple systems nest within a single user platform, performance insights maybe obtained.

Use Case: An Engineman Second Class is proficient at identifying a failed fire pump. She successfully troubleshoots to determine root cause, orders parts, and then fixes the equipment. The information and expediency by which that action is taken resides on a ServiceGraph™ profile. As more insights and trends are developed, the Navy may better understand its workforce.

Supply SaaS Applications could Include:

| Feature | Benefit |
|---|---|
| Integrated ILS | After system fails, Sailors can diagnose |
| | a discrepancy and then cross reference |
| | parts support information. |
| Integrated R-Supply | Part information at the site of repairs |

The maintenance organization's success rests on the shoulders of Petty Officers and the Senior Enlisted Leadership. Repair Parts Petty Officers (RPPOs) and Work center Supervisors (WCS) are the most active within this body. Mobile-first resources to integrate the existing programs of record will greatly improve shipboard readiness.

Training is the backbone of delivering and sustaining surface ship readiness. In 2010, the Navy implemented a four-phased readiness program: Train, Operate, Sustain, and Maintain. These elements of readiness are outlined in the COMNAVSURFLANT/PAC Instruction 2502.3, the Surface Force Readiness Manual (SFRM). In order to improve fleet readiness, the SFRM guidance deepens a commitment to material inspections and establishes a methodology committed to renewed standards. Training, focused on engineering and combat systems, and tactics training within the art of warfare, occupy much of a sailor's professional life. Their lifestyle is fast-paced, and are often expected to maintain outdated equipment while learning training standards across several warfare areas—force protection, damage control, engineering, and other key areas.

The invention aims to modernize the training process by invigorating underutilized existing programs and digitizing paper-based processes needed to save sailors time. Discussions with ATG leaders revealed a need for mobile training tools across all four areas of readiness defined above. A “safe-to-train” application would increase a ship's ability to get through engineering and damage control training more efficiently.

Ultimately, every training opportunity and exchange will be documented in a mobile-first ecosystem. The invention endeavors to create the critical applications needed to improve access to training modules and their usage rates. Once the platform is established, training channels and user generated content (UGC) will be the norm in shipboard training. Training recording systems, presently TORIS/TFOM, will be more accurate and commanders will be able to make better decisions based on improved information.

Training SaaS applications could include:

| Feature | Benefit |
|---|---|
| ATG Digital ASA Checksheets | No more paper, tracked hits with |
| | less re-work |
| Accurate ISIC/TYCOM Updates | Providing transparency to reporting |
| | requirements |
| Safe-to-Train Tracker | Training days lost due to poor |
| | prioritization |
| Mobile-Navy Knowledge Online | Expensive online education will be |
| | adopted |

The invention is designed to support UNCLAS and “For Official Use Only” (FOUO) information. Cyber-security is central to any SaaS product for the Navy. In order to prevent spillage, the invention may elect not to maintain information relating to ordnance, targeting locations, mission modules, or force protection operations. Maintaining security of hardware devices and ensuring there is a secure WIFI/cloud connection is essential.

Delivering an intuitive, specially designed user experience requires the combination of technical competency and practical knowhow. Using experienced advisors in the technical community and a staff of commercial software experts, the invention will adapt to sailor needs because the software will change based on the user feedback—this is the power of SaaS.

The Platform Hub for Daily Work

A technology platform must be a one-stop hub for Navy-sanctioned enterprise apps. Someday, there will be 30-40 mobile applications for Navy work, but they will not be designed or built by the inventors. Yet, starting with the end in mind the invention will allow those apps to tie together and to collect workforce data using application program interfaces (APIs). APIs are a set of routines, protocols, and tools for building software applications. The API specifies how software components should interact and are used when programming graphical user interface (GUI) components.

Preparing for the Future

The invention may have an immediate, positive impact on shipboard readiness but it will also set the conditions for the future SaaS of tomorrow. Wearables, the internet of things (IOT), and more sensors will come to ships in the years to come. The permeation of nanotechnology will create an even greater requirement for connected equipment. These technologies will save time for Sailors and money for the Defense Department.

Navy Personnel Command

The invention will ultimately deliver extraordinary value to Navy Personnel Command and to enlisted and officer detailers. When users perform their daily work on one integrated platform, a service graph of all their interactions is formed. How a sailor performs during an assessment? What types of emergent repairs she conducted? What skills and abilities does he have that are not being leveraged (carpentry, welding, or electronics). The invention could revolutionize how the Navy assigns sailors to cross-functional missions, supporting a multi-missioned enterprise.

### Future Applications

The exemplary embodiments disclosed herein are by way of example, and it will be appreciated by one having ordinary skill in the art that other mobile, military work environments may be usefully addressed by embodiments of the invention. For example, he scope of the invention goes beyond shipboard: the applicability of a “Mobile Readiness Platform” as disclosed herein extends across Navy (and across DoD), including (among others): shore commands (both Naval Installation Command and shore based units like NECC), aviation, submarines, special warfare commands, training commands such as Surface Warfare Officers School, and so forth.

Moreover, the invention is not limited to BYOD environments either; they are merely used as examples of how the invention may assist in creating an integrated mobile work management environment, leveraging the BYOD trend in an area where it currently is strictly separated from legacy systems and networks. For example, government-furnished mobile devices such as hardened tablets may be used interchangeably with so-called BYOD devices.

What is claimed is:

1. A system for integrated military mobile work information management comprising:
a military mobility server stored in a memory of and operating on a processor of a computing device; and
a military mobile client stored in a memory of and operating on a processor of a mobile computing device;
wherein, the military mobility server:
(a) retrieves a plurality of ship related data from a plurality of sources;
(b) persistently stores a plurality of data relating to each military unit personnel and military unit equipment;
(c) stores a plurality of document data related to military unit operations;
(d) uses analytics to predict best course action for military unit incidents and create schedules for each personnel; and
(e) wirelessly transmits data to the military mobile client;
wherein the military mobile client:
(f) receives a plurality of data types from the military mobility server;
(g) provides a graphically based work platform for each military unit personnel;
(h) graphically displays a plurality of calendar based schedules to each personnel;
(i) provides a viewing platform for a plurality of training, maintenance, repair and safety materials; and
(j) wirelessly transmits a plurality of status and report data to the military mobility server.

2. The system of claim 1, wherein at least a portion of the data related to military unit personnel and military unit equipment are organized into target specific profiles.

3. The system of claim 1, wherein at least a portion of the schedules created by the military mobility server is a calendar based work task list with at least a task and due date for task completion.

4. The system of claim 1, wherein at least a portion of the schedules created by the military mobility server is a calendar based training schedule with at least a name of each training unit, a document list for each training unit and a due date for each training unit completion.

5. The system of claim 1, wherein at least one task making use of analytics capabilities of the military mobility server is management of maintenance for all military unit equipment.

6. The system of claim 1, wherein at least one task making use of analytics capabilities of the military mobility server is management of repairs to all military unit equipment.

7. The system of claim 1, wherein at least one use of the military mobile client by each personnel is to manage their schedule commitments.

8. The system of claim 1, wherein at least one use of the military mobile client by each personnel is to electronically report observations and experiences made during watch duty.

9. The system of claim 1, wherein at least one of the military mobile clients communicates with the military mobility server over a 4G wireless data network connection.

10. The system of claim 1, wherein at least one of the military mobile clients communicates with the military mobility server over a secure WiFi wireless data network connection.

11. A method for integrated military mobile work information management comprising
the steps of:
a) receiving a plurality of military unit related data from a plurality of data sources using a military mobility server stored in a memory of and operating on a processor of a computing device;
b) storing a plurality of data relating to each military unit personnel and military unit equipment using a persistent data store;
c) employing analytics programming to predict best course of action for military unit incidents and to create schedules for each military unit personnel;
d) communicating with a military mobile client device using a secure wireless network connection;
e) displaying a plurality of calendar based military unit personnel scheduling data in an easy to read and rapidly comprehend graphical format using the military mobile client device;
f) providing a viewing platform for plurality of training, maintenance, repair, and safety materials using military mobile client device;
g) transmit a plurality of status and report data to military mobility server from military mobile client device.

12. The method of claim 11, wherein at least a portion of the data related to military unit personnel and military unit equipment are organized into target specific profiles.

13. The method of claim 11, wherein at least a portion of the schedules created by the military mobility server is a calendar based work task list with at least a task and due date for task completion.

14. The method of claim 11, wherein at least a portion of the schedules created by the military mobility server is a calendar based training schedule with at least a name of each training unit, a document list for each training unit and a due date for each training unit completion.

15. The method of claim 11, wherein at least one task making use of analytics capabilities of the military mobility server is management of maintenance for all military unit equipment.

16. The method of claim 11, wherein at least one task making use of analytics capabilities of the military mobility server is management of repairs to all military unit equipment.

17. The method of claim 11, wherein at least one use of the military mobile client by each personnel is to manage their schedule commitments.

18. The method of claim 11, wherein at least one use of the military mobile client by each personnel is to electronically report observations and experiences made during watch duty.

19. The method of claim 11, wherein at least one of the military mobile clients communicates with the military mobility server over a 4G wireless data network connection.

20. The method of claim 11, wherein at least one of the military mobile clients communicates with the military mobility server over a secure WiFi wireless data network connection.
